(19) United States
(12) Patent Application Publication
(10) Pub. No.: US 2022/0231286 A1
(43) Pub. Date: Jul. 21, 2022

(54) Composite Lithium-metal Anodes for Enhanced Energy Density and Reduced Charging Times

(71) Applicant: Google LLC, Mountain View, CA (US)

(72) Inventors: Taisup Hwang, Santa Clara, CA (US); Dookyoung Lee, Mountain View, CA (US); Lei Cao, San Jose, CA (US)

(21) Appl. No.: 17/618,332

(22) PCT Filed: Nov. 11, 2019
(86) PCT No.: PCT/US2019/060765

§ 371 Date: Dec. 10, 2021

Related U.S. Application Data
(60) Provisional application No. 62/865,015, filed on Jun. 21, 2019.

(51) Int. Cl. H01M 4/36; H01M 4/04; H01M 4/38

(52) U.S. Cl. CPC H01M 4/366; H01M 4/0404; H01M 4/583; H01M 2300/0034; H01M 4/382

(57) ABSTRACT

Example embodiments relate to composite lithium-metal anodes for enhanced energy density and reduced charging times. One embodiment includes an electrode. The electrode includes a protective layer. The electrode also includes a current collecting layer. Further, the electrode includes an active layer disposed between the protective layer and the current collecting layer. The active layer includes a graphite layer. The active layer also includes a hard carbon layer. Further, the active layer includes a lithium-metal layer.

### CROSS-REFERENCE TO RELATED APPLICATIONS

The present application claims priority to U.S. Provisional Patent Application No. 62/865,015 filed on Jun. 21, 2019, the contents of which are hereby incorporated by reference.

### BACKGROUND

Batteries can be used to temporarily provide electrical power to various devices when those devices are not connected to an external power source, for example. For a variety of masons, batteries (and specifically rechargeable batteries) have become increasingly prevalent in many technology areas. The lithium-ion battery is an example of a rechargeable battery.

In order to improve performance in applications that make use of rechargeable batteries, it may be desirable to miniaturize such batteries, reduce the charging time for such batteries, and/or increase capacity of such batteries.

### SUMMARY

The specification and drawings disclose embodiments that relate to composite lithium-metal anodes for enhanced energy density and reduced charging times. The composite anode may include a graphite layer, a hard carbon layer, and a lithium-metal layer, each of which may have various thicknesses. The composite of layers of various materials may produce an anode that exhibits a blend of various qualities associated with each of the constituent materials. For example, the composite anode may have enhanced storage at a low state of charge substantially due to the graphite layer, reduced charging time substantially due to the hard carbon layer, and enhanced overall storage capacity substantially due to the lithium-metal layer. The composite anode may also include a protective layer that minimizes side reactions between the anode and an electrolyte of a battery that includes the anode.

In a first aspect, an electrode is disclosed. The electrode includes a protective layer. The electrode also includes a current collecting layer. Further, the electrode includes an active layer disposed between the protective layer and the current collecting layer. The active layer includes a graphite layer. The active layer also includes a hard carbon layer. Further, the active layer includes a lithium-metal layer.

A thickness of the graphite layer may be between 20% and 30% of a thickness of the active layer.

A thickness of the hard carbon layer may be between 40% and 60% of a thickness of the active layer.

A thickness of the lithium-metal layer may be between 20% and 30% of a thickness of the active layer.

A thickness of the protective layer may be between 1.0 μm and 5.0 μm.

The protective layer may comprise an ex-situ ceramic layer.

The protective layer may comprise an ex-situ layer of Li₃N, Li₃AlN₂, AlN, or SiN.

The protective layer may comprise an in-situ LiF layer.

The protective layer may comprise a composite of an ex-situ ceramic layer, an ex-situ layer of LiN, Li₃AlN₂, AlN, or SiN, and an in-situ LiF layer.

The electrode may further comprise an additional active layer disposed between an additional protective layer and the current collecting layer, wherein the additional active layer is on a side of the current collecting layer opposite the active layer and wherein the additional active layer comprises: an additional graphite layer; an additional hard carbon layer; and an additional lithium-metal layer.

In a second aspect, a lithium-ion battery is disclosed. The lithium-ion battery includes a cathode that includes a cathode current collecting layer. The lithium-ion battery also includes an anode. The anode includes a protective layer. The anode also includes an anode current collecting layer. Further, the anode includes an active layer disposed between the protective layer and the anode current collecting layer. The active layer includes a graphite layer. The active layer also includes a hard carbon layer. Further, the active layer includes a lithium-metal layer. In addition, the lithium-ion battery includes an electrolyte disposed between the cathode and the anode.

The cathode may comprise LiCoO₂, LiNiCoMnO₂, or LiNiCoAlO₂.

The lithium-ion battery may be a pouch cell or a prismatic cell.

The electrolyte may be a solution comprising: a salt of lithium bis(fluorosulfonyl)imide (LiFSI); and an ether or a fluorinated ether.

In a third aspect, a method of fabrication is disclosed. The method includes applying a graphite layer onto a current collecting layer. The method also includes applying a hard carbon layer onto the graphite layer. Further, the method includes applying a lithium-metal layer onto the hard carbon layer. In addition, the method includes applying a protective layer onto the lithium-metal layer.

The graphite layer may be applied onto the current collecting layer using a web-coating process.

The hard carbon layer may be applied onto the graphite layer using a web-coating process.

The lithium-metal layer may be applied onto the hard carbon layer using an electrochemical deposition process.

The protective layer may be applied onto the lithium-metal layer using an atomic layer deposition (ALD) process or a web-coating process.

The current collecting layer, the graphite layer, the hard carbon layer, the lithium-metal layer, and the protective layer may collectively form an anode, and the method may further comprise: positioning a cathode adjacent to and separated from the anode; encapsulating the cathode and the anode within a casing; and inserting an electrolyte into an interstice defined by a separation between the cathode and the anode.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1A is an illustration of a battery, according to example embodiments.

FIG. 1B is an illustration of a battery, according to example embodiments.

FIG. 2A is a cross-section of an anode, according to example embodiments.

FIG. 2B is a cross-section of an anode, according to example embodiments.

FIG. 2C is a cross-section of an anode, according to example embodiments.

FIG. 2D is a cross-section of an anode, according to example embodiments.

FIG. 3A is a front-view illustration of a battery, according to example embodiments.

FIG. 3B is a side-view illustration of a battery, according to example embodiments.

FIG. 4 is a flow chart illustrating a method, according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

### I. Overview

Example embodiments relate to composite lithium-metal anodes for enhanced energy density and reduced charging times.

Lithium-ion batteries are the battery of choice for a number of applications, such as consumer electronics and electric vehicles. It continues to be desirable to improve the volumetric energy density and gravimetric energy density of lithium-ion batteries, while reducing the charging time for such batteries. One technique used to improve the energy density/capacity of lithium-ion batteries is to employ a lithium-metal anode. Batteries with lithium-metal anodes may have enhanced capacities when compared to batteries having more conventional anodes (e.g., graphite anodes). However, anodes made solely of lithium metal can present their own challenges, such as reduced coulombic efficiencies (e.g., low charge/discharge efficiency), dendritic growth (which can lead to a short circuit within the battery between the cathode and the anode), inadequate charging rate (e.g., maximum charging rate of 0.1 C, which corresponds to a charging time between 10 hours and 20 hours in some cases), and/or challenges in fabrication.

Other anode materials may have alternate benefits when used within a lithium-ion battery. For example, graphite anodes may be adept at energy storage for low states of charge and hard carbon anodes may exhibit fast charging and enhanced lithium plating. Embodiments described herein attempt to combine all these benefits by including each of these materials in a single anode. For example, one embodiment includes an anode that has a graphite layer, a hard carbon layer, and a lithium-metal layer. Such an anode may provide enhanced volumetric energy density (e.g., a 30%-50% increase over lithium-ion batteries with alternate lithium-metal anodes) while maintaining an acceptable charging rate. The relative thicknesses of each layer may be designed so as to emphasize and/or optimize the advantage of one of the materials more than another. For instance, in an embodiment where storage capacity is of paramount importance, the thickness of the lithium-metal layer may be greater than the thickness of the hard carbon layer and the thickness of the graphite layer.

In addition to the three layers described above (e.g., the graphite layer, the hard carbon layer, and the lithium-metal layer), the anode may also include a protective layer (e.g., an ex-situ ceramic protective layer, an in-situ LiF protective layer, or a protective layer that includes an ex-situ layer of Li₃N, Li₃AlN₂, AlN, or SiN). The protective layer may minimize side reactions between the anode and an electrolyte of the corresponding battery, which may reduce or prevent the formation of dendrites within the battery. Further, in some embodiments, the anode may include a current collecting layer (e.g., a copper current collector). The current collecting layer may provide a connection between the anode and outside circuitry (e.g., a connection to a load that is being powered by the battery).

Anodes that include the graphite layer, the hard carbon layer, the lithium-metal layer, the protective layer, and the current collecting layer may be practical for mass production using industry manufacturing techniques. For example, the graphite layer may be coated onto the current collecting layer using a web-coating process, the hard carbon layer may be coated onto the graphite layer using a web-coating process, the lithium-metal layer may be deposited onto the hard carbon layer using an electrochemical deposition process, and the protective layer may be deposited onto the lithium-metal layer using an atomic layer deposition process or coated onto the lithium-metal layer using a web-coating process.

The composite anode described above may be combined with a high-voltage cathode (e.g., a LiCoO₂ (LCO) cathode, a LiNiCoMnO₂ (NCM) cathode, or a LiNiCoAlO₂ (NCA) cathode) within a battery. Such a battery may also include a separator and an electrolyte. Depending on the intended application, a battery that includes the anode described above may have a variety of form factors. For example, such a battery may be a pouch cell or a prismatic cell.

### II. Example Devices

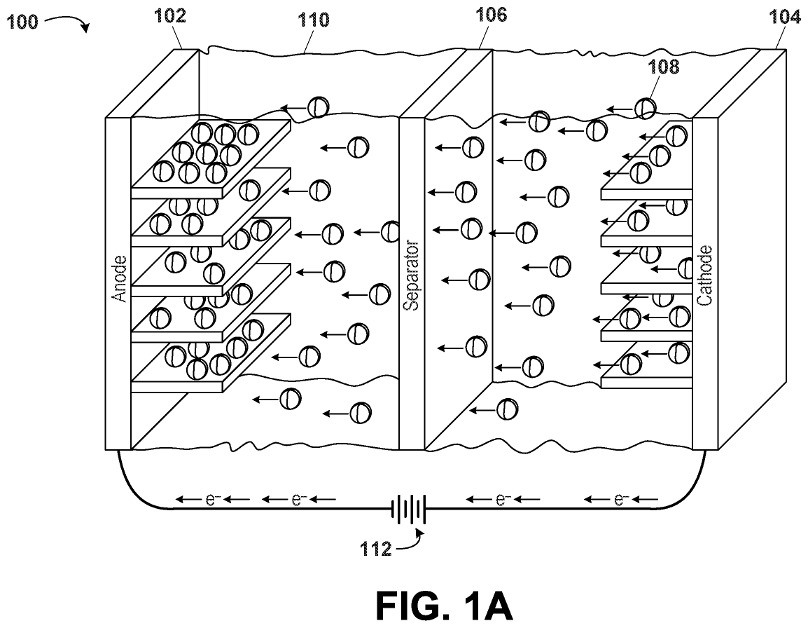

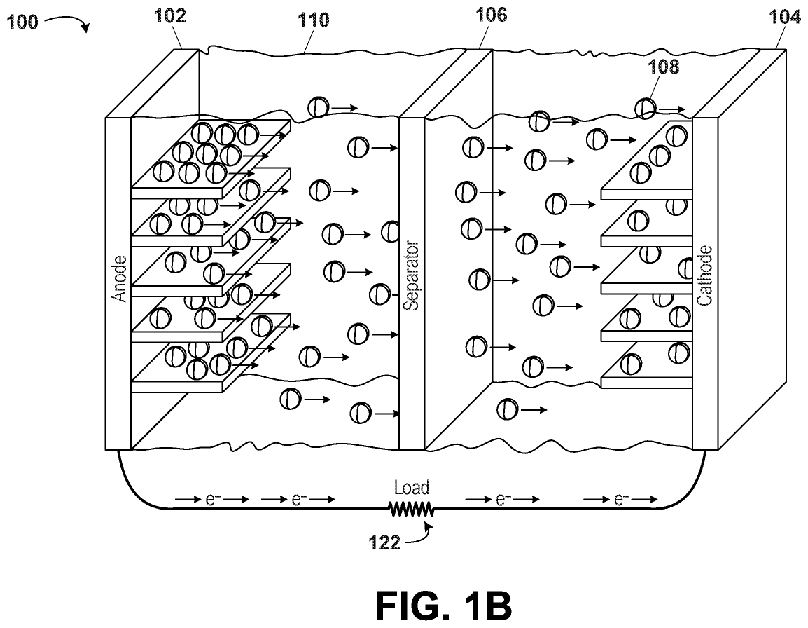

FIG. 1A is an illustration of a battery 100 (e.g., a single-celled battery). The battery 100 may be a rechargeable lithium-ion battery, for example. The battery 100 may include an anode 102, a cathode 104, a separator 106, and free lithium ions 108 within an electrolyte 110. The elements of the battery 100 are not necessarily illustrated to scale (e.g., the free lithium ions 108 may be significantly smaller than illustrated in the figure). Further, as illustrated in FIG. 1A, the battery 100 may be chargeable by an electrical power source 112 (e.g., a rectified alternating current (AC) signal, a separate charged battery, or a charged capacitor). In some embodiments, multiple cells of cathode, anode, separator, and electrolyte may be electrically arranged in series and/or parallel to form a composite battery. Such cell arrangements may enhance the capacity and/or voltage of the composite battery. The battery 100 may provide electrical power to one or more devices (e.g., consumer-electronic devices).

Charging may include electrons flowing from the cathode 104 to the anode 102 through circuitry external to the battery 100. In addition, charging may include free lithium ions 108, within the electrolyte 110, flowing from the cathode 104 to the anode 102 through the separator 106. Further, charging may include the free lithium ions 108 being intercalated into the anode 102. Such a process is illustrated in FIG. 1A by the lithium ions that are sitting on “shelves” of the anode 102. The charging may represent a first formation charging process, in some embodiments. The first formation charging process may last between 10 hours and 20 hours, in some embodiments. Additionally, the battery 100 may be configured to undergo repeated charge/discharge cycles during a lifetime of the battery 100. For example, the battery 100 may be a rechargeable battery configured to be charged by an external voltage between 4.20 volts and 4.50 volts or between 4.40 volts and 4.60 volts. It will be understood that other external charge voltage values and/or ranges are possible and contemplated herein.

In various embodiments, various charging/recharging schemes may be used. For example, a constant voltage (CV) scheme may be used, where a constant voltage is applied across the terminals of the battery, resulting in a decreasing current as the battery charges, until the current reaches 0.0 Amps (or within a threshold current of 0.0 Amps), at which point the voltage source charging the battery is removed. In other embodiments, a constant current (CC) scheme may be used, where the voltage applied across the terminals of the battery by a charging device is varied such that the current is maintained at a constant rate. Once the battery voltage reaches a threshold value to maintain the continuous current, the battery may be determined to be charged, and the voltage source charging the battery may be removed.

Alternatively, in some embodiments, a hybrid constant current/constant voltage (CC/CV) charging mode may be used to charge the battery. The CC/CV charging mode may have two stages. In a first stage (a CC stage), the voltage may be increased continuously to maintain a constant current charging the battery. Then, once the voltage reaches a certain maximum charging voltage threshold, the second stage of the CC/CV charging mode may begin. In the second stage (a CV stage), the voltage may be maintained at the maximum charging voltage threshold, and the charging current may be allowed to decrease. Once the charging current reaches a threshold level, indicating the battery is charged, the CC/CV charging mode may cease.

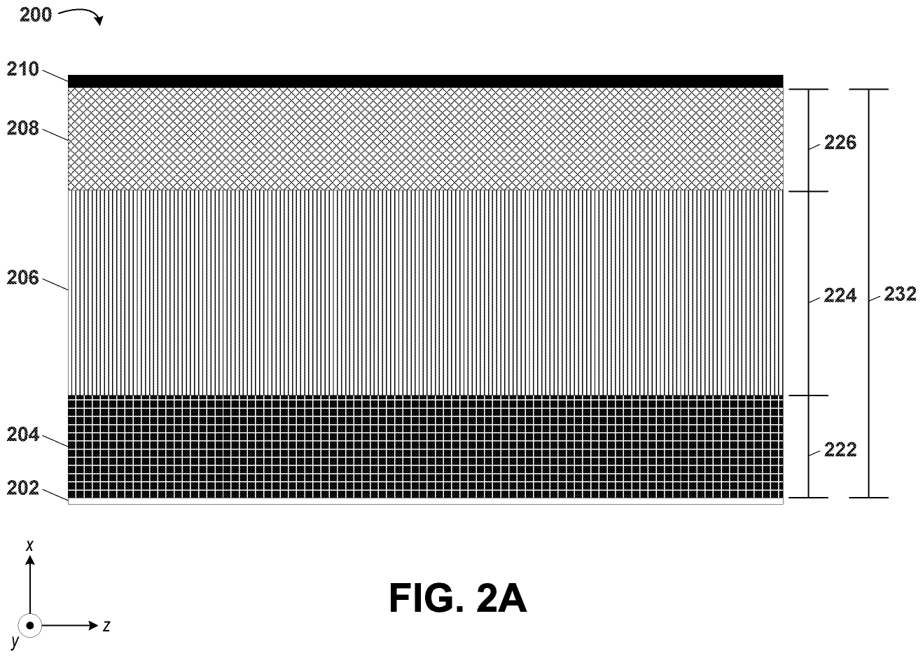

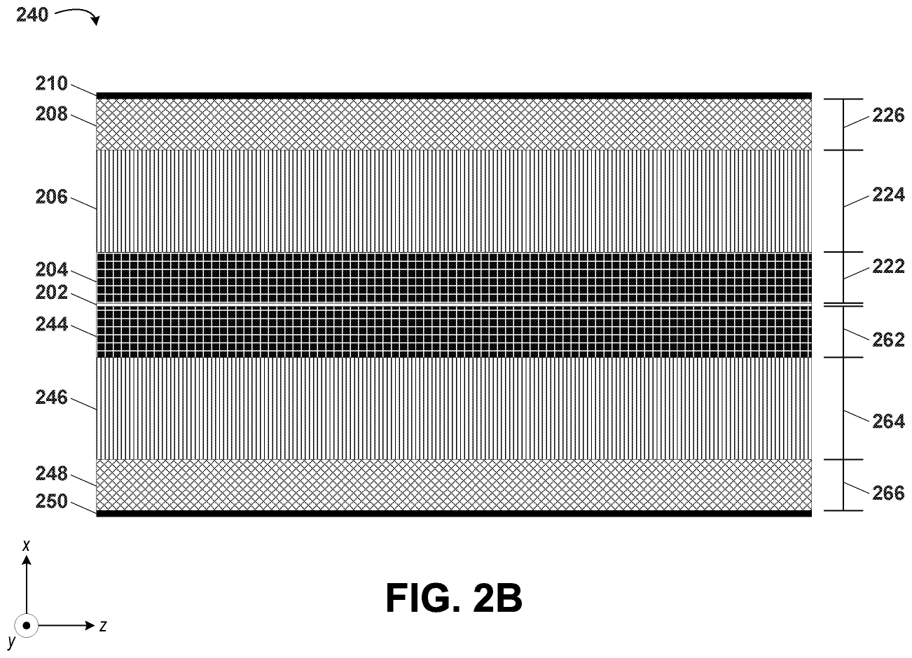

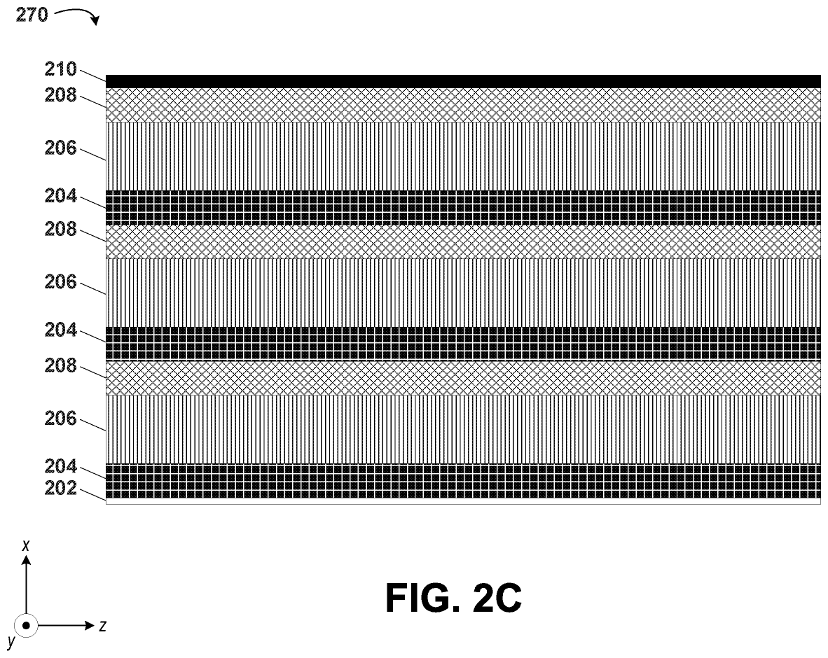

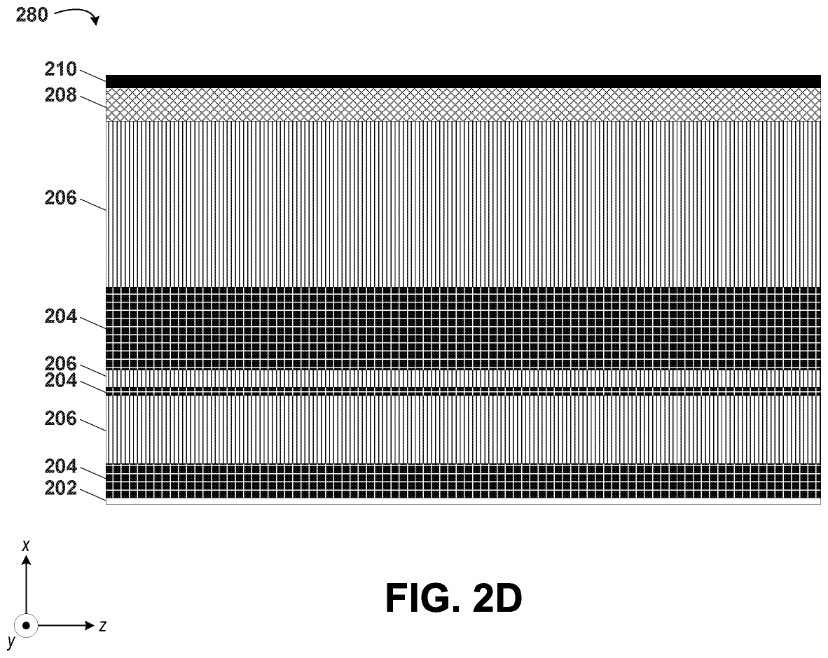

The anode 102 may be the negative terminal (electrode) of the battery 100. For example, the anode 102 may include one or more external electrical contacts (e.g., current collectors) on the side of the anode 102 facing away from the separator 106. The external electrical contact(s) may allow an electrical connection between the anode 102 and the power source 112 or a load to be made. The anode 102 may include graphite, Li. Li₄TiO₁₂, a lithium-metal composite, a hard carbon, and/or Si, in various embodiments. Further, as described below with reference to FIGS. 2A-2D, the anode 102 may include a multilayered composite structure.

The cathode 104 may be the positive terminal (electrode) of the battery 100. For example, the cathode 104 may include one or more external electrical contacts (e.g., current collectors) on the side of the cathode 104 facing away from the separator 106. The external electrical contact(s) may allow an electrical connection between the cathode 104 and the power source 112 or a load to be made. The cathode 104 may include LiCoO₂ (LCO), LiMn₂O₄, a vanadium oxide, LiNiCoMnO₂ (NCM). LiNiCoAlO₂ (NCA), an olivine (e.g., LiFePO₄), or a composite of two or more of such materials, in various embodiments. LCO may be used in applications where enhanced volumetric energy density is valued (e.g., consumer-electronic devices, such as mobile devices). Additionally or alternatively, NCM may be used in applications where enhanced gravimetric energy density is valued (e.g., electric vehicles). Other lithium-containing cathode materials are possible and contemplated herein.

The separator 106 may prevent a short circuit of the cathode 104 to the anode 102 within the battery 100. For example, the separator 106 may include a semi-permeable membrane (e.g., permeable to the free lithium ions 108). To achieve such semi-permeability, the separator 106 may include micropores that are sized to selectively allow the passage of the free lithium ions 108 during charging or discharging processes. The semi-permeable membrane of the separator 106 may also have an amorphous or a semi-crystalline structure. Further, the semi-permeable membrane of the separator 106 may be polymeric (e.g., fabricated from cellulose acetate, nitrocellulose, cellulose esters, polysulfone, polyether sulfone, polyacrilonitrile, polyamide, polyimide, polyethylene, polypropylene, polytetrafluoroethylene, polyvinylidene fluoride, polyvinylchloride, and/or aramid). In addition, the separator 106 may be chemically and electrochemically stable for use within the battery 100 during charging and discharging processes. In some embodiments, the separator 106 may include a multi-layered structure.

In some embodiments, the separator 106 may be a non-standard separator having an increased mechanical stability, which can prevent dendrites from piercing the separator 106. Further, the separator 106 may also include compounds that are chemically and/or electrochemically stable for use within the battery 100 during charging or discharging processes. Such compounds may enhance the lifetime of the battery 100, for example.

In some embodiments, the battery 100 may be a thin-film battery. In such embodiments, the battery 100 may not include a separator 106. Further, in such embodiments, the electrolyte 110 may be solid (e.g., rather than liquid), thereby satisfying purposes of both the electrolyte 110 and the separator 106 (e.g., transporting ions and preventing a short circuit of the cathode 104 to the anode 102). In such embodiments, a discrete separator may not be needed.

The free lithium ions 108 may transfer between the anode 102 and the cathode 104 during charging/discharging processes of the battery 100. In some embodiments, the free lithium ions 108 may originate from the cathode 104. For example, the cathode 104 may include LiCoO₂, which may be a source of free lithium during the chemical reactions occurring during the charging process (e.g., during the first formation charging process). Other sources of free lithium ions are also possible. For example, the anode 102 may provide free lithium ions and/or lithium salts (e.g., LiPF₆, LiBF₄, LiBC₄O₈, Li[PF₃(C₂F₅)₃], LiClO₄, or LiC₂F₆NO₄S₂ (i.e., lithium bis(fluorosulfonyl)imide (LiFSI))) dissolved within the electrolyte 110 may provide free lithium ions.

The electrolyte 110 may be a medium through which the free lithium ions 108 travel during charging and discharging processes of the battery 100. The electrolyte 110 may be a gel or a liquid, in various embodiments and/or at various temperatures. For example, the electrolyte 110 may be an organic solvent (e.g., ethylene carbonate, dimethyl carbonate, diethyl carbonate, an ether, or a fluorinated ether). Additives may be included within the electrolyte 110 to enhance the effectiveness of the electrolyte 110. In some embodiments, for instance, ionic liquids may be included within the electrolyte to reduce volatility of the electrolyte solution.

As described above, in some embodiments (e.g., embodiments where the battery 100 is a thin-film battery), the electrolyte 110 may be a solid (e.g., rather than a liquid or gel). For example, in some embodiments, the electrolyte 110 may include one or more amorphous glassy layers deposited on the cathode 104 (e.g., deposited using sputtering or vapor deposition). One type of amorphous glassy material that may be used is lithium phosphorous oxynitride (LiPON).

FIG. 1B is another illustration of the battery 100. The battery 100 illustrated in FIG. 1B may be discharging across a load 122. Discharging the battery 100 may include electrons flowing from the anode 102 to the cathode 104, across the load 122, through circuitry external to the battery 100. Discharging the battery 100 may also include the free lithium ions 108 within the electrolyte 110 flowing from the anode 102 to the cathode 104 through the separator 106 (in embodiments having a discrete separator). Further, discharging the battery 100 may include the free lithium ions 108 being intercalated into the cathode 104. Such a scenario is illustrated in FIG. 1B by the lithium ions that are sitting on “shelves” of the cathode 104.

The load 122 may be a device powered by the battery 100, such as an electric vehicle, a hybrid electric vehicle, a mobile device, a tablet computing device, a laptop computing device, a light source, television remote, headphones, etc. The load 122 may be powered by the flow of electrons through the circuitry external to the battery 100 during the discharging process, for example.

FIG. 2A is a cross-section of an anode 200, according to example embodiments. The anode 200 includes a current collecting layer 202, an active layer (which includes a graphite layer 204, a hard carbon layer 206, and a lithium-metal layer 208), and a protective layer 210.

The current collecting layer 202 may be used to connect the anode 200 to one or more components external to the battery. For example, the current collecting layer 202 may be used to connect the anode 200 to a charging circuit (e.g., a wall charger) or to a load across which the battery may be discharged to provide power (e.g., an electric vehicle or a mobile device). The current collecting layer 202 may include one or more metallic layers (e.g., one or more metallic foil sheets). For example, the current collecting layer 202 may include copper. Additionally or alternatively, the current collecting layer 202 may include aluminum, stainless steel, zinc, titanium, silver, palladium, nickel, iron, chromium, or an alloy thereof. The thickness of the current collecting layer 202 (e.g., dimension of the current collecting layer 202 measured along the x-direction illustrated in FIG. 2A) may be between 5 μm and 15 μm (e.g., between 8 μm and 12 μm), in some embodiments.

The graphite layer 204 may be located adjacent to the current collecting layer 202 and/or the hard carbon layer 206, in some embodiments. For example, in some embodiments, the graphite layer 204 may have been applied onto the current collecting layer 202 using a web-coating process. Graphite (as in the graphite layer 204) is a hexagonally organized crystalline form of carbon. The graphite layer 204 may be a portion of the active layer configured to store energy for use at low states of charge. Further, the graphite layer 204 portion of the active layer may be chargeable using an intermediate charging current (e.g., a maximum charging current between 0.7 C and 1.0 C). For reference, the “C-rate” (i.e., 1.0 C) of a battery is equal to the current at which the total capacity of the battery (in terms of charge) flows by a given point in the span of an hour. For example, a 1.0 C charging current for a 2,500 mAh battery equals 2.5 A. Likewise, a 0.5 C discharging current for a 3,000 mAh battery equals 1.5 A. Further, a 2.0 C charging current for a 1,700 mAh battery is 3.4 A.

The thickness 222 of the graphite layer 204 is illustrated in FIG. 2A. As illustrated, the thickness 222 of the graphite layer 204 may be the dimension of the graphite layer 204 measured along the x-axis. The thickness 222 of the graphite layer 204 may be different in various embodiments. For example, the thickness 222 of the graphite layer 204 may be between 20% and 30% of an overall thickness 232 of the active region of the anode 200 (as measured in the x-direction, as illustrated). Further, in some embodiments, the graphite layer 204 may store between 12.5% and 37.5% of an energy capacity of the anode 200 (e.g., about 25%).

The hard carbon layer 206 may be located adjacent to the graphite layer 204 and/or the lithium-metal layer 208, in some embodiments. For example, in some embodiments, the hard carbon layer 206 may have been applied onto the graphite layer 204 using a web-coating process. Hard carbon (as in the hard carbon layer 206) is an irregular and disordered form of carbon (e.g., synthesized by pyrolysis of polymers). The hard carbon layer 206 may be a portion of the active layer configured to be charged quickly (e.g., due to efficient lithium plating inside voids within the hard carbon crystal structure). For example, the hard carbon layer 206 portion of the active layer may be chargeable using a relatively large charging current (e.g., a maximum charging current between 1.0 C and 1.5 C).

The thickness 224 of the hard carbon layer 206 is illustrated in FIG. 2A. As illustrated, the thickness 224 of the hard carbon layer 206 may be the dimension of the hard carbon layer 206 measured along the x-axis. The thickness 224 of the hard carbon layer 206 may be different in various embodiments. For example, the thickness 224 of the hard carbon layer 206 may be between 40% and 60% of an overall thickness 232 of the active region of the anode 200 (as measured in the x-direction, as illustrated). Further, in some embodiments, the hard carbon layer 206 may store between 37.5% and 62.5% of an energy capacity of the anode 200 (e.g., about 50%).

The lithium-metal layer 208 may be located adjacent to the hard carbon layer 206 and/or the protective layer 210, in some embodiments. For example, in some embodiments, the lithium-metal layer 208 may have been applied onto the hard carbon layer 206 using an electrochemical deposition process. The lithium-metal layer 208 may be a portion of the active layer configured to exhibit a high energy storage capacity. Further, the lithium-metal layer 208 portion of the active layer may be chargeable using a relatively small charging current (e.g., a maximum charging current between 0.1 C and 0.2 C).

The thickness 226 of the lithium-metal layer 208 is illustrated in FIG. 2A. As illustrated, the thickness 226 of the lithium-metal layer 208 may be the dimension of the lithium-metal layer 208 measured along the x-axis. The thickness 226 of the lithium-metal layer 208 may be different in various embodiments. For example, the thickness 226 of the lithium-metal layer 208 may be between 20% and 30% of an overall thickness 232 of the active region of the anode 200 (as measured in the x-direction, as illustrated). Further, in some embodiments, the lithium-metal layer 208 may store between 12.5% and 37.5% of an energy capacity of the anode 200 (e.g., about 25%).

In some embodiments, the maximum charging rate of a battery that includes the composite anode (e.g., a maximum charging current in terms of C-rate) may be determined empirically. Further, such a maximum charging rate may depend on: the size, shape, and/or materials used to fabricate a corresponding cathode; the size, shape, and/or materials used to fabricate the corresponding electrolyte; and/or the size, shape, and/or materials used to fabricate the corresponding separator. Additionally or alternatively, such a maximum charging rate may depend on the mass ratio or thickness ratio of the layers within the active layer of the anode 200 (e.g., the mass ratio of the graphite layer 204 to the hard carbon layer 206 to the lithium-metal layer 208).

The protective layer 210 may be used to protect the anode 200 from other components of the battery. For example, the protective layer 210 may be used to minimize side reactions between the anode 200 and an electrolyte (e.g., the electrolyte 110 of the battery 100 illustrated in FIGS. 1A and 1B). The protective layer 210 may include various materials. For example, the protective layer 210 may include an ex-situ ceramic layer (i.e., a ceramic layer that was formed separately from the anode 200 and then incorporated into the anode 200). Additionally or alternatively, the protective layer 210 may include an in-situ LiF layer (i.e., a LiF layer that was formed in place within the anode 200). Further, the protective layer 210 may include an ex-situ layer of LiN, Li₃AlN₂, AlN, and/or SiN. In still other embodiments, the protective layer 210 may include a composite of an ex-situ ceramic laver; an ex-situ layer of Li₃N, Li₃AlN₂, AlN, and/or SiN; and/or an in-situ LiF layer. Even further, in some embodiments, the protective layer 210 may include a solid polymer layer.

The protective layer 210 may be disposed within the anode 200 adjacent to the active layer (e.g., adjacent to the lithium-metal layer 208 within the active layer). For example, in some embodiments, the protective layer 210 may have been applied onto the lithium-metal layer 208 using an atomic layer deposition (ALD) process or a web-coating process. In addition, the thickness of the protective layer 210 (e.g., dimension of the protective layer 210 measured along the x-axis) may be between 1.0 μm and 5.0 μm (e.g., between 2.0 μm and 3.0 μm), in some embodiments.

It is understood that the anode 200 illustrated in FIG. 2A is provided only as an example, and that other embodiments are also possible. For example, in some embodiments, the relative thicknesses of the current collecting layer 202, the graphite layer 204, the hard carbon layer 206, the lithium-metal layer 208, and the protective layer 210 may be different than illustrated in FIG. 2A (e.g., the relative thickness of the hard carbon layer 206 could be increased to enhance the maximum charging/discharging rate of a battery that includes the anode 200 and/or the relative thickness of the lithium-metal layer 208 could be increased to enhance the volumetric energy density of a battery that includes the anode 200). Additionally or alternatively, the relative positions of the layers within the active layer (e.g., the graphite layer 204, the hard carbon layer 206, and the lithium-metal layer 208) may also be different than illustrated in FIG. 2A. For example, in other embodiments, the bottom layer of the active layer may be the hard carbon layer 206, the middle layer of the active layer may be the lithium-metal layer 208, and the top layer of the active layer may be the graphite layer 204.

Additionally or alternatively, in some embodiments, there may be layers of the anode on both sides of the current collecting layer 202 (e.g., to enhance the energy storage density of the anode). For example, as in the anode 240 illustrated in FIG. 2B, some anodes may include multiple active layers and multiple protective layers (e.g., where such active layers and protective layers are positioned symmetrically about the current collecting layer 202). As illustrated, FIG. 2B is a cross-section of an anode 240, according to example embodiments. The anode 240 includes a current collecting layer 202, an active layer (which includes a graphite layer 204, a hard carbon layer 206, and a lithium-metal layer 208), a protective layer 210, an additional active layer (which includes an additional graphite layer 244, an additional hard carbon layer 246, and an additional lithium-metal layer 248), and an additional protective layer 250. The additional active layer may be positioned on a side of the current collecting layer 202 that is opposite the active layer, as illustrated. Layers of the additional active layer and/or the additional protective layer 250 may be fabricated using the respective techniques described above with respect to the active layer and the protective layer 210 (e.g., a web-coating process, an electrochemical deposition process, and/or an ALD process).

As illustrated in FIG. 2B, the active layer/the protective layer 210 and the additional active layer/the additional protective layer 250 may be symmetric within the anode 240. In alternate embodiments, other arrangements are also possible. For example, in some embodiments, the additional active layer may be thicker or thinner than the active layer. Similarly, in some embodiments, thicknesses of individual layers within the additional active layer may be different from thicknesses of individual layers within the active layer. For example, a thickness 262 of the additional graphite layer 244 may be different than the thickness 222 of the graphite layer 204, a thickness 264 of the additional hard carbon layer 246 may be different than the thickness 224 of the hard carbon layer 206, and/or a thickness 266 of the additional lithium-metal layer 248 may be different than the thickness 226 of the lithium-metal layer 208.

Additionally or alternatively, in some embodiments, the additional protective layer 250 may be thicker or thinner than the protective layer 210. Still further, in some embodiments, the relative positions of the additional graphite layer 244, the additional hard carbon layer 246, and/or the additional lithium-metal layer 248 within the additional active layer may be different from the relative positions of the graphite layer 204, the hard carbon layer 206, and/or the lithium-metal layer 208 within the active layer.

Additional embodiments (e.g., other than those illustrated in FIGS. 2A and 2B) are also possible. In some embodiments, an anode (e.g., the anode 270 illustrated in FIG. 2C) may include an active layer that has more than three layers. For example, the anode 270 of FIG. 2C includes an active layer that has nine layers (e.g., three graphite layers 204, three hard carbon layers 206, and three lithium-metal layers 208). It is understood that other numbers of layers are also possible (e.g., four, five, six, seven, eight, ten, etc.). The design of FIG. 2C may provide for a thicker anode while making use of the same fabrication techniques described above. For example, a web-coating process may be capable of producing layers of a predefined thickness. Hence, in order to achieve an increased mass of a given material, applying multiple web-coated layers may be more practical than attempting to apply a single web-coated layer of an increased thickness. In some embodiments, for example, the mass ratio of graphite to hard carbon to lithium metal in the active layer may be the same in FIG. 2C as in FIG. 2A, even though the numbers of layers of each are different. In other embodiments, the nine layers of FIG. 2C may be arranged differently (e.g., all of the similar layers may be adjacent to one another, such as each of the three graphite layers 204 being positioned adjacent to one another).

Additionally, the anode 270 of FIG. 2C could include additional active layer(s) on an opposite side of the current collecting layer 202 (e.g., similar to the anode 240 illustrated in FIG. 2B). Any additional active layer(s) on an opposite side of the current collecting layer 202 may have the same or different numbers of layers than the active layer illustrated in FIG. 2C. Further, any additional active layers(s) on an opposite side of the current collecting layer 202 may have a different arrangement and or relative thickness of the layers interior to the additional active layer(s) than the active layer pictured in FIG. 2C.

Even further, in some embodiments, there may not be equal numbers of graphite layers 204, hard carbon layers 206, and lithium-metal layers 208. For example, as illustrated in the anode 280 of FIG. 2D, there may be multiple graphite layers 204 (e.g., three graphite layers 204), multiple hard carbon layers 206 (e.g., three hard carbon layers 206), and a single lithium-metal layer 208. It is understood that other combinations are also possible and contemplated herein (e.g., one graphite layer 204, two hard carbon layers 206, and three lithium-metal layers 208). Also as illustrated in FIG. 2D, in some embodiments, different layers of the same material may have different thicknesses. For example, each of the graphite layers 204 in FIG. 2D has a different thickness. Similarly, as illustrated in FIG. 2D, each of the hard carbon layers 206 has a different thickness.

Alternatively, in some embodiments, an anode may not include discrete layers (e.g., as illustrated in FIGS. 2A-2D). Instead, an anode may include an amorphous active layer that is an alloy of different materials (e.g., with a given mass ratio to exhibit desired properties of the anode, such as a mass ratio of graphite to hard carbon to lithium-metal similar to the active layers of FIGS. 2A and 2B).

Anodes described here (e.g., the anodes 200/240/270/280 illustrated in FIGS. 2A-2D) may be components of lithium-ion batteries (e.g., along with cathodes, electrolytes, and/or separators, as in the battery 100 illustrated in FIG. 1A). For example, the anodes described herein may be paired with a high-voltage cathode (e.g., a LCO cathode, a NCM cathode, a NCA cathode, or a cathode that is a composite of LCO, NCM, and/or NCA) within a lithium-ion battery. Such lithium-ion batteries may have a maximum charged voltage between 2.5 volts and 4.4 volts (e.g., depending on the composition of the cathode).

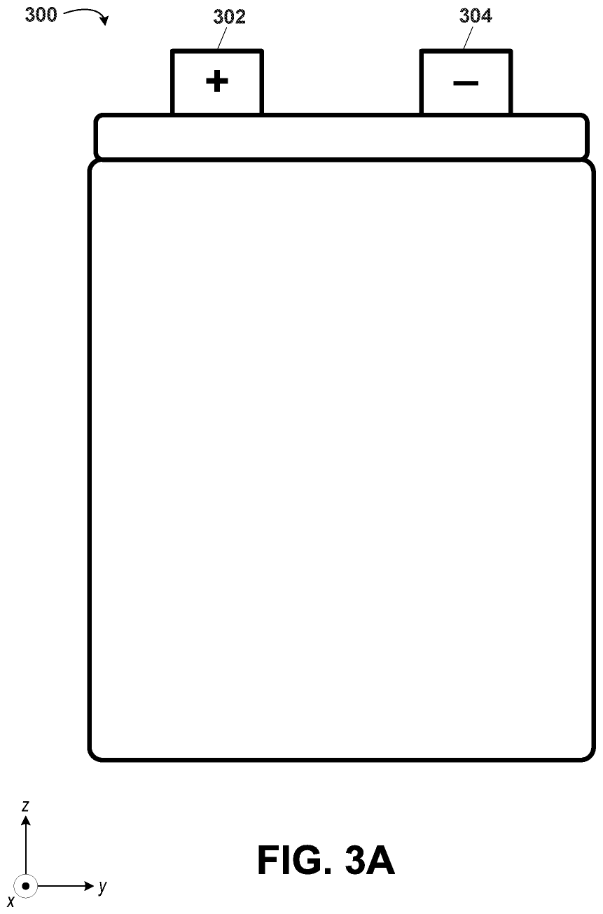

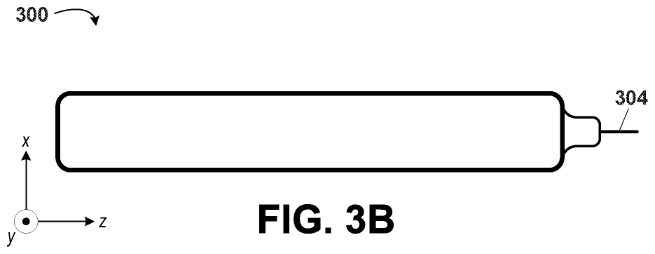

In various embodiments, the lithium-ion batteries described herein may take a variety of form factors. For example, a lithium-ion battery 300 that include the anodes 200/240/270/280 illustrated in FIGS. 2A-2D is illustrated in FIGS. 3A and 3B. FIG. 3A is a front-view illustration (e.g., from a perspective perpendicular to the x-axis) of the lithium-ion battery 300 and FIG. 3B is a side-view illustration (e.g., from a perspective perpendicular to the y-axis) of the lithium-ion battery 300. As illustrated, the lithium-ion battery 300 may be a pouch cell. Also as illustrated, the lithium-ion battery 300 may have a positive terminal with a positive lead 302 (e.g., connected to the cathode of the lithium-ion battery 300) and a negative terminal with a negative lead 304 (e.g., connected to the anode of the lithium-ion battery 300) defined within the pouch cell.

In alternate embodiments, the lithium-ion battery 300 may take other forms. For example, the lithium-ion battery 300 may be a prismatic cell, a coin cell (e.g., a CR2032 coin cell), or a jellyroll cell. Such a jellyroll conformation may be encapsulated in a metallic or plastic cylindrical casing (e.g., to prevent leakage of electrolyte solution and/or to enhance safety in the case of battery failure). In some embodiments, the lithium-ion battery 300 may have an enhanced gravimetric energy density when in the pouch form factor as when compared to the jellyroll form factor because no cylindrical casing is used in the pouch conformation.

In some embodiments, the lithium-ion battery 300 may supply electrical power to components of a device (e.g., a consumer-electronic device). For example, the lithium-ion battery 300 may be connected to circuitry within the device (e.g., electrically coupled to a motherboard within the device). Further, the lithium-ion battery 300 may be connectable to an external power source (e.g., a wall socket) in order to recharge the lithium-ion battery 300. Alternatively, the lithium-ion battery 300 could be charged via wireless charging (e.g., using inductive coupling with an external power source).

### III. Example Processes

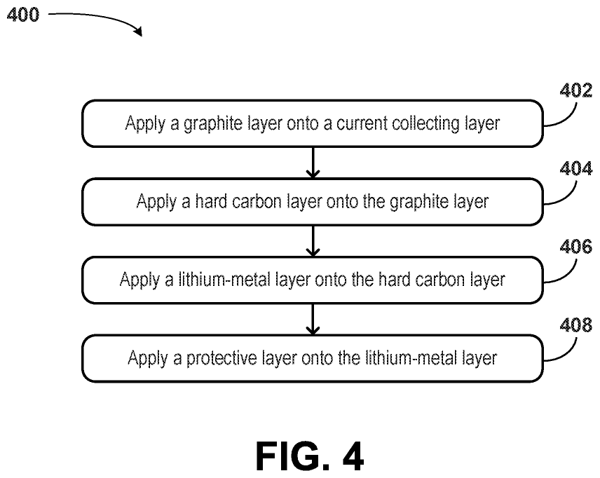

FIG. 4 is a flow chart illustrating a method 400 of fabrication. The method 400 may be performed to fabricate a battery (e.g., a battery that includes the anode 200 illustrated in FIG. 2A).

At block 402, the method 400 may include applying a graphite layer onto a current collecting layer. In some embodiments, the graphite layer may be applied onto the current collecting layer using a web-coating process. Web-coating processes may include passing a flexible material (e.g., a film) over multiple rollers and printing or otherwise depositing an additional material onto the flexible material. For example, the current collecting layer may be a flexible copper layer passed over multiple rollers onto which the graphite layer is coated.

At block 404, the method 400 may include applying a hard carbon layer onto the graphite layer. In some embodiments, the hard carbon layer may be applied onto the graphite layer using a web-coating process. For example, a composite of the graphite layer and the current collecting layer may be passed over multiple rollers, and the hard carbon layer may be coated onto the composite.

At block 406, the method 400 may include applying a lithium-metal layer onto the hard carbon layer. In some embodiments, the lithium-metal layer may be applied onto the hard carbon layer using an electrochemical deposition process (e.g., an electroplating process). For example, a composite of the current collecting layer, the graphite layer, and the hard carbon layer may be submerged or partially submerged in a solution that has dissolved lithium-metal ions. After submerging or partially submerging such a composite, an electric current may be applied such that a reduction reaction actions, thereby plating the lithium-metal on the hard carbon layer.

At block 408, the method 400 may include applying a protective layer onto the lithium-metal layer. In some embodiments, protective layer may be applied onto the lithium-metal layer using an ALD process or a web-coating process. For example, a composite of lithium-metal layer, the hard carbon layer, the graphite layer, and the current collecting layer may be passed over multiple rollers, and the protective layer may be coated onto the composite (e.g., in embodiments where the protective layer includes an ex-situ ceramic layer or an ex-situ layer of Li₃N, Li₃AlN₂, AlN, and/or SiN). Alternatively, LiF (e.g., a thin film of LiF) may be applied (e.g., in situ) to the composite using ALD by introducing precursors (e.g., lithd and TiF₄) near the surface of the lithium-metal layer.

In some embodiments, the current collecting layer, the graphite layer, the hard carbon layer, the lithium-metal layer, and the protective layer may collectively form an anode. Further, the method 400 may include positioning a cathode adjacent to and separated from the anode. The method 400 may also include encapsulating the cathode and the anode within a casing. Further, the method 400 may include inserting an electrolyte into an interstice defined by a separation between the cathode and the anode.

### IV. Conclusion

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration only and are not intended to be limiting, with the true scope being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. An electrode comprising:
a protective layer;
a current collecting layer; and
an active layer disposed between the protective layer and the current collecting layer, wherein the active layer comprises:
a graphite layer;
a hard carbon layer; and
a lithium-metal layer.

2. The electrode of claim 1, wherein a thickness of the graphite layer is between 20% and 30% of a thickness of the active layer.

3. The electrode of claim 1, wherein a thickness of the hard carbon layer is between 40% and 60% of a thickness of the active layer.

4. The electrode of claim 1, wherein a thickness of the lithium-metal layer is between 20% and 30% of a thickness of the active layer.

5. The electrode of claim 1, wherein a thickness of the protective layer is between 1.0 μm and 5.0 μm.

6. The electrode of claim 1, wherein the protective layer comprises an ex-situ ceramic layer.

7. The electrode of claim 1, wherein the protective layer comprises an ex-situ layer of Li₃N, Li₃AlN₂, AlN, or SiN.

8. The electrode of claim 1, wherein the protective layer comprises an in-situ LiF layer.

9. The electrode of claim 1, wherein the protective layer comprises a composite of an ex-situ ceramic layer, an ex-situ layer of Li₃N, Li₃AlN₂, AlN, or SiN, and an in-situ LiF layer.

10. The electrode of claim 1, further comprising an additional active layer disposed between an additional protective layer and the current collecting layer,
wherein the additional active layer is on a side of the current collecting layer opposite the active layer,
wherein the additional active layer comprises:
an additional graphite layer;
an additional hard carbon layer; and
an additional lithium-metal layer.

11. A lithium-ion battery comprising:
a cathode comprising a cathode current collecting layer;
an anode comprising:
a protective layer;
an anode current collecting layer; and
an active layer disposed between the protective layer and the anode current collecting layer, wherein the active layer comprises:
a graphite layer;
a hard carbon layer; and
a lithium-metal layer; and
an electrolyte disposed between the cathode and the anode.

12. The lithium-ion battery of claim 11, wherein the cathode comprises LiCoO₂, LiNiCoMnO₂, or LiNiCoAlO₂.

13. The lithium-ion battery of claim 11, wherein the lithium-ion battery is a pouch cell or a prismatic cell.

14. The lithium-ion battery of claim 11, wherein the electrolyte is a solution comprising:
a salt of lithium bis(fluorosulfonyl)imide (LiFSI); and
an ether or a fluorinated ether.

15. A method of fabrication comprising:
applying a graphite layer onto a current collecting layer;
applying a hard carbon layer onto the graphite layer;
applying a lithium-metal layer onto the hard carbon layer; and
applying a protective layer onto the lithium-metal layer.

16. The method of claim 15, wherein the graphite layer is applied onto the current collecting layer using a web-coating process.

17. The method of claim 15, wherein the hard carbon layer is applied onto the graphite layer using a web-coating process.

18. The method of claim 15, wherein the lithium-metal layer is applied onto the hard carbon layer using an electrochemical deposition process.

19. The method of claim 15, wherein the protective layer is applied onto the lithium-metal layer using an atomic layer deposition (ALD) process or a web-coating process.

20. The method of claim 15,
wherein the current collecting layer, the graphite layer, the hard carbon layer, the lithium-metal layer, and the protective layer collectively form an anode, and
wherein the method further comprises:
positioning a cathode adjacent to and separated from the anode;
encapsulating the cathode and the anode within a casing; and
inserting an electrolyte into an interstice defined by a separation between the cathode and the anode.
